(19) United States
(12) Patent Application Publication
(10) Pub. No.: US 2019/0044848 A1
(43) Pub. Date: Feb. 7, 2019

(54) VIRTUAL SWITCHING FRAMEWORK

(71) Applicant: Hewlett Packard Enterprise Development LP, Houston, TX (US)

(72) Inventors: Harish Shivaram, Bangalore (IN); Daniel N. Goodman, Roseville, CA (US); Chivukula Koundinya, Bangalore (IN)

(21) Appl. No.: 15/665,643

(22) Filed: Aug. 1, 2017

(51) Int. Cl. H04L 12/703; H04L 12/931; H04L 12/709; H04L 12/751

(52) U.S. Cl. CPC H04L 45/28; H04L 49/70; H04L 41/044; H04L 45/02; H04L 49/351; H04L 45/245

(57) ABSTRACT

A non-transitory machine readable medium may store instructions executable by a processing resource to cause a device to detect a failure of a switch among a plurality of switches associated with a virtual switching framework (VSF), disable multicast traffic through the VSF responsive to detection of the failure of the switch, and alter a topology associated with the VSF. The instructions may be further executable by the processing resource to receive a notification indicating that the topology associated with the VSF has been altered and re-enable multicast traffic through the VSF responsive to the notification that the topology associated with the VSF has been altered.

### BACKGROUND

Internet protocol (IP) packets may be routed through a virtual switching framework en route to their destination. However, IP packets may be duplicated or looped if a failure occurs in the virtual switching framework.

### BRIEF DESCRIPTION OF THE DRAWINGS

FIG. 1 illustrates an example of a virtual switching framework consistent with the disclosure.

FIG. 2 illustrates an example of a virtual switching framework and source consistent with the disclosure.

FIG. 3 illustrates an example of a virtual switching framework and source with a failed link consistent with the disclosure.

FIG. 4 illustrates an example flow diagram for a virtual switching framework consistent with the disclosure.

FIG. 5 illustrates another example flow diagram for a virtual switching framework consistent with the disclosure.

FIG. 6 illustrates an example non-transitory machine-readable medium for a virtual switching framework consistent with the disclosure.

FIG. 7 illustrates an example flow diagram of a method for a virtual switching framework consistent with the disclosure.

### DETAILED DESCRIPTION

Front plane stacking (FPS) is a network virtualization technology which virtualizes multiple physical switches into one virtual switching framework (VSF), which may be referred to herein as a VSF stack. In some examples, the FPS techniques may include virtualizing multiple switches in the layer into one VSF. FPS may provide resiliency, scalability, and/or higher bandwidth as compared to some approaches.

FPS may allow for supported switches to be coupled to one another through dedicated point-to-point Ethernet communication links (e.g., cables), which may be referred to herein as “FPS links.” In some examples, the FPS links may be copper wires (e.g., twisted pairs), fiber optic pipe, or other links suitable for transmitting data in a network. The FPS links may carry encapsulated data plane traffic, and/or may exchange control plane traffic such that the VSF maintains its topology and/or state. In some examples, the FPS links may exchange such traffic in a manner that facilitates the VSF stack behaving like a single logical switch.

Various topologies (e.g., ring, stack, standalone, etc.) may be supported within a VSF stack in order to provide high availability and/or scalability, for example. During operation of the VSF stack, the topology associated with the VSF may be altered. In some examples, the topology associated with the VSF stack may be altered due to a failure of a switch in the VSF or the failure of a FPS link in the VSF stack. When such a failure occurs, the traffic (e.g., unicast and/or multicast data traffic) being propagated through the VSF may be affected. For example, traffic propagated through the stack may be duplicated and/or looped through the stack, which may adversely affect an end user experience. However, examples of the present disclosure allow for duplicated and/or looped traffic to be minimized or eliminated in the event of a topology change in the VSF stack due to a failure of a switch or FPS link.

Examples of the disclosure include machine-readable media, systems, and methods for a virtual switching framework. In some examples, a non-transitory machine readable medium may store instructions executable by a processing resource to cause a device to detect a failure of a switch among a plurality of switches associated with a virtual switching framework (VSF), disable multicast traffic through the VSF responsive to detection of the failure of the switch, and alter a topology associated with the VSF. The instructions may be further executable by the processing resource to receive a notification indicating that the topology associated with the VSF has been altered and re-enable multicast traffic through the VSF responsive to the notification that the topology associated with the VSF has been altered.

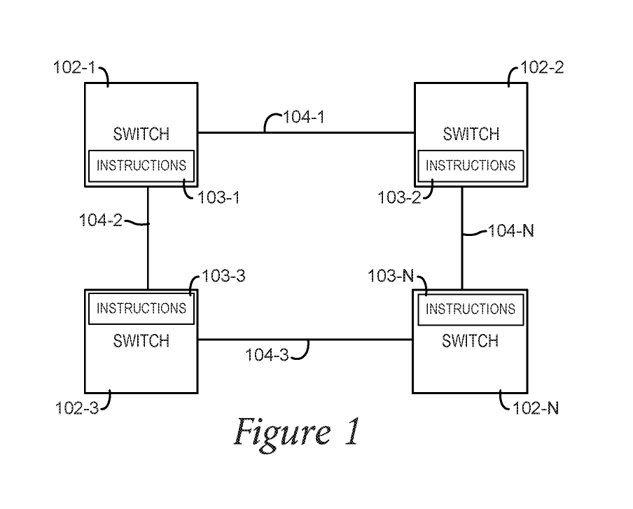

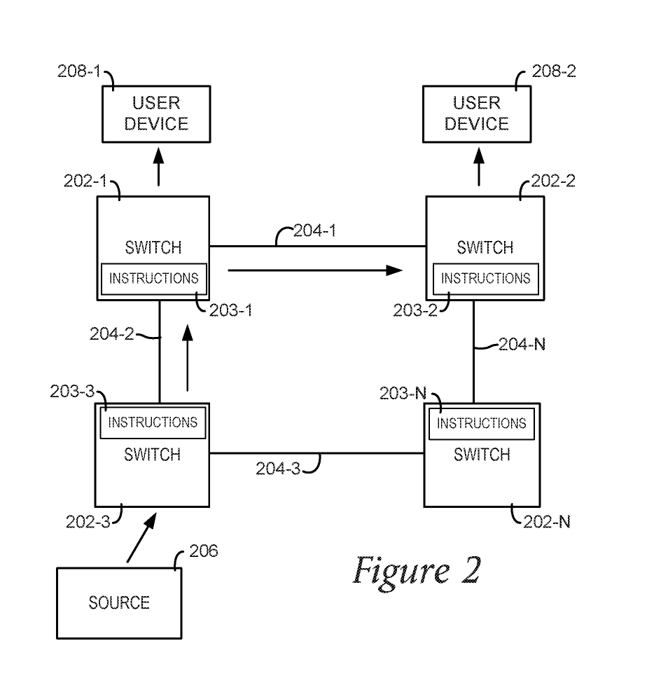

The figures herein follow a numbering convention in which the first digit corresponds to the drawing figure number and the remaining digits identify an element or component in the drawing. For example, reference numeral 104 may refer to element “04” in FIG. 1 and an analogous element may be identified by reference numeral 204 in FIG. 2. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

FIG. 1 illustrates an example of a virtual switching framework consistent with the disclosure. As shown in FIG. 1, a VSF may include a plurality of switches 102-1, . . . , 102-N coupled via respective FPS links 104-1, . . . , 104-N. The FPS links 104-1, . . . , 104-N may serve as logical interfaces that connect the switches 102-1, . . . , 102-N of the VSF. In some examples, physical links assigned to a FPS link 104-1, . . . , 104-N may automatically form an aggregated virtual chassis. As described above, each FPS link 104-1, . . . , 104-N may carry encapsulated data plane traffic and/or control plane traffic to maintain the topology and/or state of the VSF stack. Although the topology of the VSF shown in FIG. 1 is a ring topology, the VSF may have any topology (e.g., chain, standalone, etc.).

As used herein, a “ring topology” is a topology in which each switch 102-1, . . . , 102-N is connected to exactly two other switches 102-1, . . . , 102-N such that a continuous pathway for data signals is provided through each switch 102-1, . . . , 102-N, whereas a “chain topology” is a topology in which each switch 102-1, . . . , 102-N is connected in series to the next such that a linear pathway for data signals is provided to each switch 102-1, . . . , 102-N. A “standalone topology” is a topology in which a single switch (e.g., switch 102-1) is deployed.

Each switch 102-1, . . . , 102-N in the VSF may be assigned a specific role during operation of the VSF. For example, a first switch 102-1 may be assigned the role of commander, a second switch 102-2 may be assigned the role of standby, and the remaining switches 102-3, 102-N may be assigned the role of member switches. The commander switch (e.g., switch 102-1) may have control and management plane protocols running thereon. The commander switch may also be responsible for managing forwarding databases (e.g., media access control tables) for the VSF. In some examples, the commander switch may synchronize the forwarding databases with the other switches 102-2, . . . , 102-N (e.g., the standby switch and member switches) of the VSF.

The standby switch (e.g., switch 102-2) may function as a stateful backup device for the commander switch. As used herein, a “stateful backup device” is a device that actively processes and/or retains state data. In some examples, the standby switch may take control of the VSF (e.g., may perform the duties of the commander switch) if the commander switch is removed or fails. This may allow for the VSF to continue operations seamlessly during removal or failure of the commander switch.

The remaining switches (e.g., switches 102-3, 102-N) that are neither the commander switch nor the standby switch in the VSF are referred to as member switches. In some examples, the member switches do not run any networking protocols and do not have any states associated therewith (e.g., the member switches may be stateless devices). The ports on the member switches may be directly controlled and programmed by the commander switch. In response to the standby switch taking control of the VSF (e.g., in response to a removal or failure of the commander switch), one of the member switches may be upgraded to the role of standby switch.

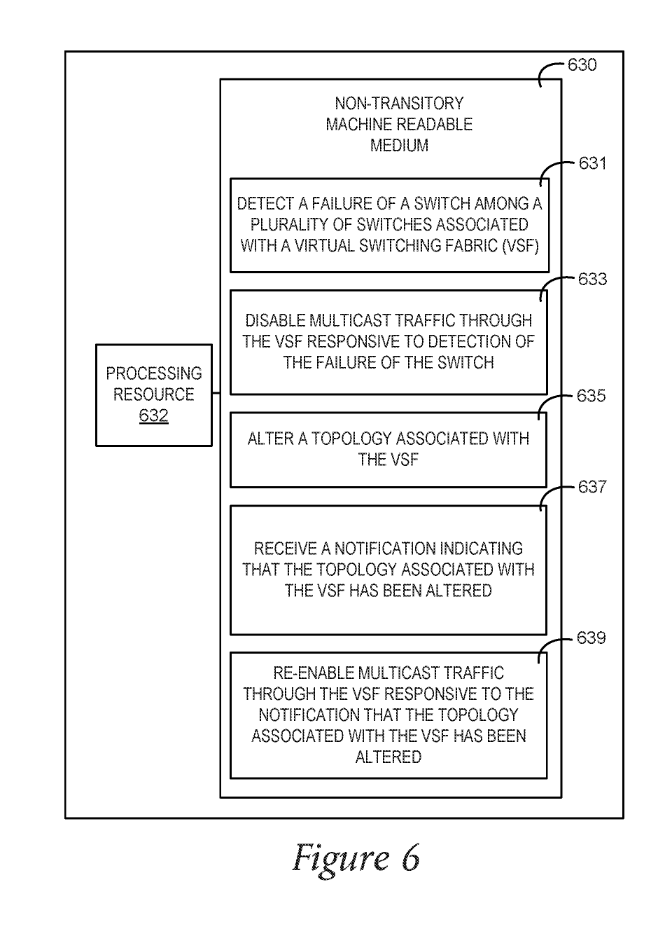

As shown in FIG. 1, each of the switches 102-1, . . . , 102-N may include instructions 103-1, . . . , 103-N. The instructions may be stored in a memory associated with each of the switches 102-1, . . . , 102-N. The memory may be any type of volatile or non-volatile memory or storage, such as random access memory (RAM), flash memory, read-only memory (ROM), storage volumes, a hard disk, or a combination thereof. In some examples, the instructions may correspond to instructions 631, 633, 635, 637, and/or 639, which are described in more detail herein in connection with FIG. 6. The instructions may be executed by one or more processing resources, which may be associated with the switches 202-1, . . . , 202-N. As used herein, a “processing resource” is an electronic circuit that performs operations on an external data source such as a memory. For example, a processing resource may be used to execute instructions stored on a memory to cause some action to occur.

FIG. 2 illustrates an example of a virtual switching framework and source consistent with the disclosure. As shown in FIG. 2, a VSF may include a plurality of switches 202-1, . . . , 202-N coupled via respective FPS links 204-1, . . . , 204-N. The FPS links 204-1, . . . , 204-N may serve as logical interfaces that connect the switches 202-1, . . . , 202-N of the VSF. As described above, each FPS link 204-1, . . . , 204-N may carry encapsulated data plane traffic and/or control plane traffic to maintain the topology and/or state of the VSF stack. A plurality of user devices 208-1, 208-2 may be provided to receive data traffic (e.g., multicast traffic) from the VSF as indicated by the arrow between switch 202-1 and user device 208-1 and the arrow between switch 202-2 and user device 208-2.

A source 206 may provide data traffic (e.g., multicast data traffic) to the VSF as indicated by the arrow between source 206 and switch 202-3. In some examples, the data traffic may propagate from switch 202-3 via FPS link 204-2 to switch 202-1, as indicated by the arrow between switch 202-3 and switch 202-1. This traffic may then be provided to user device 208-1 from switch 202-1, In addition, the data traffic may propagate from switch 202-1 via FPS link 204-1 to switch 202-2, as indicated by the arrow between switch 202-1 and switch 202-2. This traffic may then be provided to user device 208-2 from switch 202-2. That is, in some examples, data traffic ingressing on switch 202-1 is delivered to user device 208-1 and switch 202-2, which subsequently delivers the data traffic to user device 208-2. Similarly, in some examples, data traffic ingressing on switch 202-3 takes a path from switch 202-3 to switch 202-1 to switch 202-2 to deliver data traffic to both user device 208-1 and user device 208-2.

As shown in FIG. 2, each of the switches 202-1, . . . , 202-N may include instructions 203-1, . . . , 203-N. The instructions may be stored in a memory associated with each of the switches 202-1, . . . , 202-N. The memory may be any type of volatile or non-volatile memory or storage, such as random access memory (RAM), flash memory, read-only memory (ROM), storage volumes, a hard disk, or a combination thereof. In some examples, the instructions may correspond to instructions 631, 633, 635, 637, and/or 639, which are described in more detail herein in connection with FIG. 6. The instructions may be executed by one or more processing resources, which may be associated with the switches 202-1, . . . , 202-N.

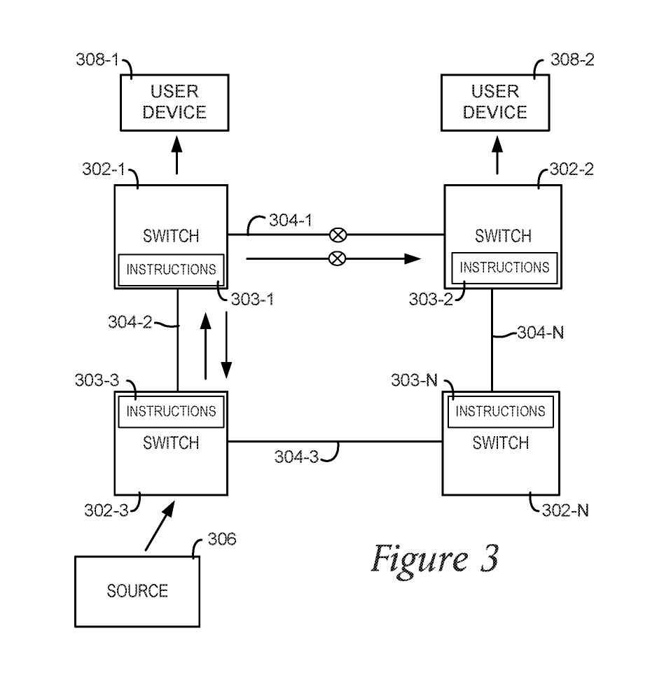

FIG. 3 illustrates an example of a virtual switching framework and source with a failed link consistent with the disclosure. As indicated by the circled “X” in the FPS link 304-1 between switch 302-1 and switch 302-2, the FPS link 304-1 has failed and data traffic is no longer able to propagate from switch 302-1 to switch 302-2 via FPS link 304-1. Although shown in FIG. 3 as a failure of the FPS link 304-1, the failure could also occur in one of the switches (e.g., switch 302-2) and/or other links (e.g., FPS link 304-2, 304-3, 304-N). In some approaches, during failure scenarios such as a link or switch failure, depending on how quickly the forwarding path may be reprogrammed on all the switches in the VSF, traffic outages may be on the order of several seconds. However, in some examples, the forwarding path may be reprogrammed on the order of milliseconds, which may reduce the duration of traffic outages as compared to some approaches.

As shown in FIG. 3, each of the switches 302-1, . . . , 302-N may include instructions 303-1, . . . , 303-N. The instructions may be stored in a memory associated with each of the switches 302-1, . . . , 302-N. The memory may be any type of volatile or non-volatile memory or storage, such as random access memory (RAM), flash memory, read-only memory (ROM), storage volumes, a hard disk, or a combination thereof. In some examples, the instructions may correspond to instructions 631, 633, 635, 637, and/or 639, which are described in more detail herein in connection with FIG. 6. The instructions may be executed by one or more processing resources, which may be associated with the switches 302-1, . . . , 302-N.

In the example shown in FIG. 3, once the failure of FPS link 304-1 (or one of the switches/links) is detected, the VSF topology may be altered from a ring topology to a chain topology. In some examples, switch 302-1 detects the failure in the FPS link 304-1 (or the failure in switch 302-2, for example) and asserts a command to alter the topology from a ring topology to a chain topology. The command to alter the topology may be asserted via a unicast transmission. As used herein, a “unicast transmission” is a transmission (comprising, for example, an IP packet) that is sent to a single recipient on a network. In contrast, a “multicast transmission” is a transmission that is sent to a group of recipients on a network. For example, a unicast transmission may be sent from switch 302-1 to switch 302-3, while a multicast transmission may be sent from switch 302-1 to switches 302-2, 303-3, and 303-N.

After the topology has been altered, data traffic ingressing on switch 302-1 now takes the path from switch 302-1 to switch 302-3 to switch 302-N to switch 302-2. In some examples, switch 302-3 may not yet have received a command indicating that the topology has changed so data traffic ingressing on switch 302-3 may take the path from switch 302-3 to switch 302-N to switch 302-2. In some approaches, this may result in user device 308-1 receiving duplicate traffic as the data traffic loops between switch 302-1 and switch 302-3, while user device 308-2 may receive no data traffic. However, by disabling multicast traffic in the VSF while the forwarding path is reprogrammed on all the switches, as described in more detail, herein, duplicate traffic received by user device 308-1 may be minimized and/or looping between switch 302-1 and switch 302-3 may be reduced or eliminated.

For example, traffic drops in VSF topologies due to a FPS link failure or switch failure can be mitigated by disabling all multicast traffic through the VSF until the new topology is programmed across the VSF stack (e.g., until the new topology is programmed on every switch in the VSF stack), and then re-enabling multicast traffic through the VSF. In some examples, this may be done when a change to the topology of the VSF can induce looping and/or traffic outages.

In some examples, VSF topology information may be exchanged between the switches using unicast communications periodically and/or during stacking events. Examples of stacking events include failures of switches, failures of FPS links, removal of switches, and/or addition of new switches to the VSF. In some examples, such stacking events may lead to a change in topology of the VSF. The topology information exchanged between the switches may be used to analyze and/or determine the current VSF topology (e.g., to determine if the current topology is a ring, chain, standalone, etc. topology), and program each switch to correctly forward data traffic through the VSF.

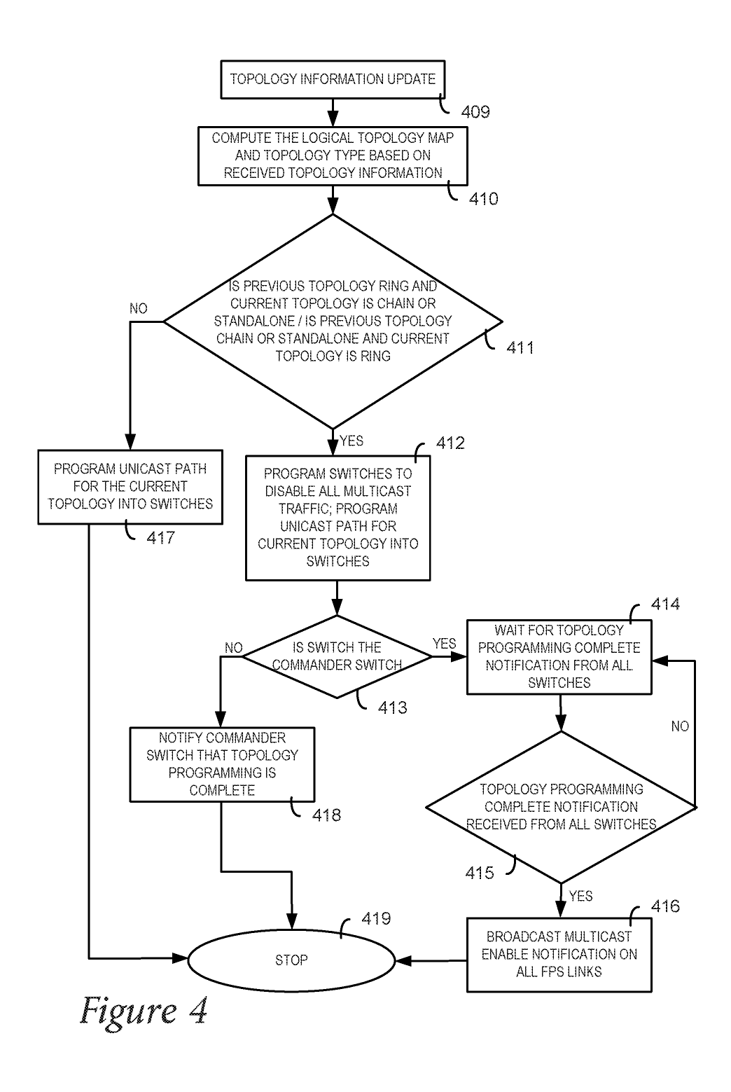

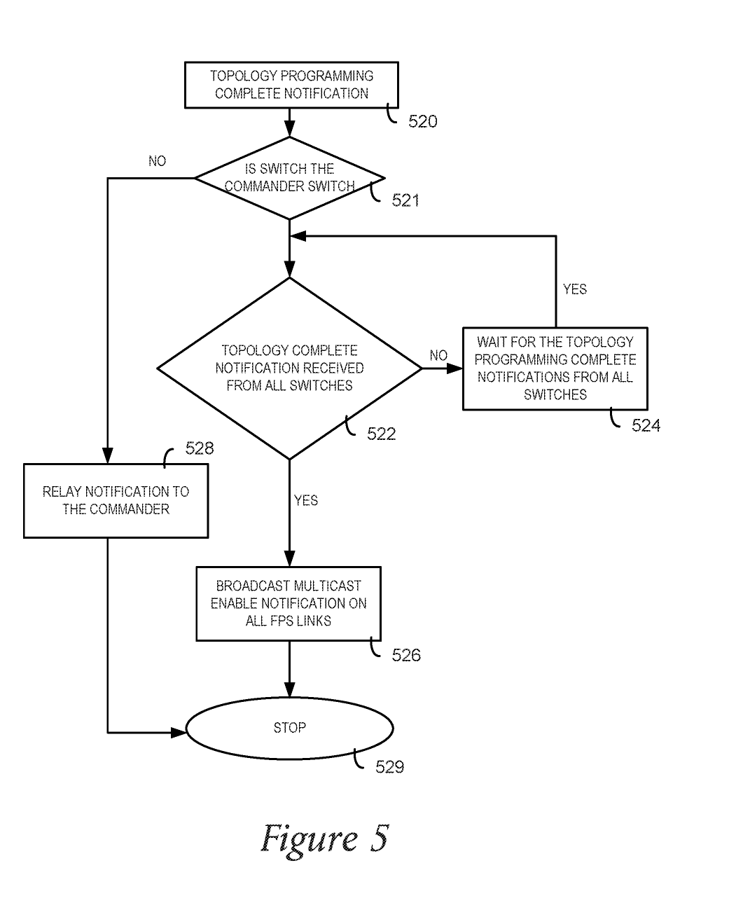

In some examples, topology information exchanged between the switches in the VSF may be used to generate a logical topology map that can include information regarding switches that are directly connected to a particular switch in the VSF and the corresponding FPS links that couple the switches to the particular switch. Each switch may store such a logical map, which may be used to determine the topology of the VSF and/or maintain the topology of the VSF. Once the topology of the VSF has been determined, each switch may perform the operations described in more detail in FIGS. 4 and 5 to disable multicast traffic through the VSF responsive to determination that a FPS link or switch has failed and program the data traffic path for a new topology of the VSF.

FIG. 4 illustrates an example flow diagram for a virtual switching framework consistent with the disclosure. As shown in FIG. 4, at block 409, a topology information update may be detected. The topology information update may include information indicating that the topology of the VSF has been altered. Subsequent to receipt of the topology information update, at block 410, the logical topology map and topology type of the VSF may be computed (e.g., determined) based on the received topology information update.

At 411, a determination may be made as to what the previous topology of the VSF and what the new topology of the VSF is. For example, a determination may be made that the previous topology was a ring topology and the current topology is a chain or standalone topology, or a determination may be made that the previous topology was a chain or standalone topology and the current topology is a ring topology. In the example of FIG. 4, the previous topology is the topology of the VSF prior to the FPS link or switch failure, and the current topology is the topology that is to be reprogrammed on each switch of the VSF in response to the failure.

If the previous topology is a ring topology and the current topology is a chain or standalone, or if the previous topology was a chain or standalone and the current topology is a ring topology, at block 412 a command may be asserted to each switch in the VSF to disable all multicast traffic through the VSF. In addition, at block 412, a unicast path may be programmed for each switch in the VSF for the current topology,

If the previous topology is not a ring topology and the current topology is not a chain or standalone, or if the previous topology was not a chain or standalone and the current topology is not a ring topology, at block 417 a unicast path for the current topology may be programmed on each switch in the VSF. That is, if no change is made to the topology of the VSF, at block 417 a unicast path for the current topology may be programmed on each switch in the VSF. In this scenario, once the unicast path is programmed on each switch in the VSF, the process stops at block 419.

Once multicast traffic through the VSF has been disabled and the unicast path has been programmed, at block 413 a determination may be made if a switch under consideration is the commander switch. For example, since each switch in the VSF disables multicast traffic independently and programs the unicast path independently, and since the commander switch is responsible for managing the VSF and synchronizing the forwarding databases with the other switches (e.g., the standby switch and other member switches in the VSF), a determination as to whether the switch under consideration is the commander switch.

If the switch under consideration is not the commander switch, at block 418, the switch can assert a command to the commander switch to notify the commander switch that the topology programming at that switch has been completed. In this scenario, once the switch notifies the commander switch that the topology programming is complete on that switch, the process stops at block 419.

If the switch under consideration is the commander switch, at block 414, the commander switch can wait until topology programming complete notifications have been received from all the switches in the VSF. At block 415, a determination can be made as to whether a notification from each switch indicating that the topology programming is complete has been received by the commander switch. If the notification has not been received for every switch in the VSF, the process can return to block 414 until the commander switch has received the notification indicating that the topology programming is complete from each switch in the VSF.

Once the commander switch has received the notification indicating that the topology has been programmed on every switch in the VSF, at block 416 a notification may be broadcast through the VSF to re-enable multicast traffic through the VSF. Subsequent to re-enabling multicast traffic through the VSF, the process may stop at block 419.

FIG. 5 illustrates another example flow diagram for a virtual switching framework consistent with the disclosure. As shown in FIG. 5, a switch in the VSF may receive a topology programming complete notification at block 520. The notification may be sent as part of a unicast transmission via a FPS link coupled to the switch that is receiving the notification. At block 521, a determination may be made if the switch that received the topology programming complete notification is the commander switch. If the switch is not the commander switch, at block 528 the notification that the topology programming is complete on that switch can be relayed to the commander switch. In this scenario, after the topology programming complete notification is relayed to the commander switch, the process may stop at block 529.

At block 522, a determination may be made as to whether or not the topology programming complete notification has been received from all member switches in the VSF. For example, a determination may be made as to whether the commander switch has received the topology programming complete notification from all the other switches (e.g., all other member switches and the standby switch) associated with the VSF.

If the topology programming complete notification has not been received from all the switches in the VSF, at block 524 the commander switch can wait for the topology programming complete notification to be received from all the other switches. While the commander switch waits for the topology programming complete notification from all switches, it can periodically check (e.g., at the “YES” branch connected to block 524) to see if the topology complete notification has been received from all switches at block 522. Once the commander switch has received the topology programming complete notification from all the switches in the VSF, the commander switch may broadcast multicast enable notifications on all FPS links at block 526, and the process may stop at block 529. For example, multicast traffic may be re-enabled through the VSF at block 526.

FIG. 6 illustrates an example non-transitory machine-readable medium for a virtual switching framework consistent with the disclosure. A processing resource 632 may execute instructions stored on the non-transitory machine readable medium 630. The non-transitory machine readable medium 630 may be any type of volatile or non-volatile memory or storage, such as random access memory (RAM), flash memory, read-only memory (ROM), storage volumes, a hard disk, or a combination thereof.

The example medium 630 may store instructions 631 executable by a processing resource 632 to detect a failure of a switch among a plurality of switches associated with a virtual switching framework (VSF). In some examples, the failure may be detected based, at least n part, on information associated with a unicast communication between switches among the plurality of switches and/or may be based, at least in part, on a failure of a front plane stacking link coupling switches among the plurality of switches. For example, a unicast communication between the switches may include information indicating that a switch (or FPS link coupling the switches) among the plurality of switches has failed, and/or a unicast transmission may not be received at a switch (or FPS link), which in turn may indicate that the switch (or FPS link) has failed.

The example medium 630 may store instructions 633 executable by a processing resource 632 to disable multicast traffic through the VSF responsive to detection of the failure of the switch. In some examples, a command may be asserted as part of a unicast transmission to disable multicast traffic through the VSF.

The example medium 630 may store instructions 635 executable by a processing resource 632 to alter a topology associated with the VSF. For example, the topology of the VSF may be altered from a ring topology to a chain or standalone topology, or the topology of the VSF may be altered from a chain or standalone topology to a ring topology. In some examples, the instructions may be further executable by the processing resource 632 to cause the device to receive an indication from each of the switches that has not failed that the altered topology has been received by each of the switches prior to re-enabling multicast traffic through the VSF. The notification that the topology has been altered may be received as part of a unicast transmission while multicast traffic is disabled through the VSF.

The example medium 630 may store instructions 637 executable by a processing resource 632 to receive a notification indicating that the topology associated with the VSF has been altered. The notification may be received as part of a unicast transmission, which may include information regarding the new topology of the VSF.

The example medium 630 may store instructions 639 executable by a processing resource 632 to re-enable multicast traffic through the VSF responsive to the notification that the topology associated with the VSF has been altered. In some examples, the instructions may be executable by the processing resource 632 to re-enable multicast traffic to respective switches among the plurality of switches responsive to receipt of an indication by the respective switches that the topology associated with the VSF has altered.

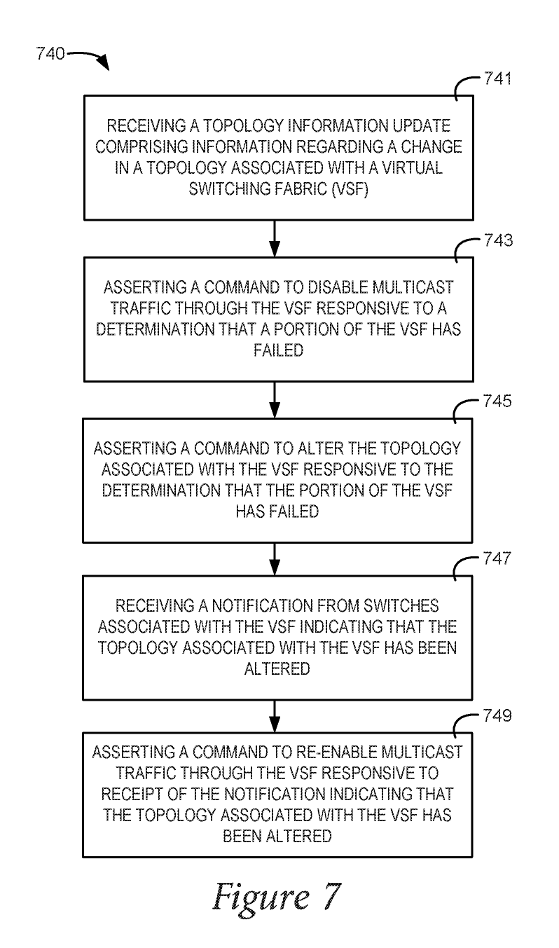

FIG. 7 illustrates an example flow diagram of a method 740 for a virtual switching framework consistent with the disclosure. At block 741, the method 740 may include receiving a topology information update comprising information regarding a change in a topology associated with a virtual switching framework.

At block 743, the method 740 may include asserting a command to disable multicast traffic through the VSF responsive to a determination that a portion of the VSF has failed. In some examples, the method 740 may further include forwarding the command to disable multicast traffic in the VSF from a first switch associated with the VSF to a second switch associated with the VSF.

At block 745, the method 740 may include asserting a command to alter the topology associated with the VSF responsive to the determination that the portion of the VSF has failed. In some examples, the method 740 may include asserting a command to alter the topology from a ring topology to a chain topology or vice versa. The command to alter the topology may be sent as part of a unicast transmission while multicast traffic is disabled through the VSF.

At block 747, the method 740 may include receiving a notification from switches associated with the VSF indicating that the topology associated with the VSF has been altered. The notification may be received as part of a unicast transmission.

At block 749, the method 740 may include asserting a command to re-enable multicast traffic through the VSF responsive to receipt of the notification indicating that the topology associated with the VSF has been altered. In some examples, the method 740 may further include asserting the command to re-enable multicast traffic through the VSF via a plurality of front plane stack (FPS) links coupling the switches to one another.

In some examples, the method 740 may further include receiving, at a commander switch, the notification from switches associated with the VSF indicating that the topology has been altered prior to asserting the command to re-enable multicast traffic through the VSF, determining, at the commander switch, that each switch associated with the VSF has altered the topology associated with the VSF based on receipt of the notification from the switches associated with the VSF, and asserting the command to re-enable multicast traffic through the VSF to each switch associated with the VSF via a unicast transmission.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. As used herein, designators such as “N”, etc., particularly with respect to reference numerals in the drawings, indicate that a number of the particular feature so designated can be included. A “plurality of” is intended to refer to more than one of such things.

What is claimed:

1. A non-transitory machine-readable medium storing instructions executable by a processing resource to cause a device to:
detect a failure of a switch among a plurality of switches associated with a virtual switching framework (VSF);
disable multicast traffic through the VSF responsive to detection of the failure of the switch;
alter a topology associated with the VSF;
receive a notification indicating that the topology associated with the VSF has been altered; and
re-enable multicast traffic through the VSF responsive to the notification that the topology associated with the VSF has been altered.

2. The non-transitory machine-readable medium of claim 1, wherein the instructions are further executable by the processing resource to cause the device to detect the failure of the switch based, at least in part, on information associated with a unicast communication between switches among the plurality of switches.

3. The non-transitory machine-readable medium of claim 1, wherein the instructions are further executable by the processing resource to cause the device to detect the failure of the switch based, at least in part, on a failure of a front plane stacking link coupling switches among the plurality of switches.

4. The non-transitory machine-readable medium of claim 1, wherein the instructions are further executable by the processing resource to cause the device to re-enable multicast traffic to respective switches among the plurality of switches responsive to receipt of an indication by the respective switches that the topology associated with the VSF has altered.

5. The non-transitory machine-readable medium of claim 1, wherein the instructions are further executable by the processing resource to cause the device to receive an indication from each of the switches that has not failed that the altered topology has been received by each of the switches prior to re-enabling multicast traffic through the VSF.

6. The non-transitory machine-readable medium of claim 1, wherein the instructions are further executable by the processing resource to cause the device to receive the notification that the topology associated with the VSF has been altered via a unicast transmission.

7. The non-transitory machine-readable medium of claim 1, wherein the instructions are further executable by the processing resource to cause the device to receive the notification that the topology associated with the VSF has been altered via a unicast transmission while multicast traffic is disabled through the VSF.

8. A system, comprising:
a plurality of member switches coupled via respective communication links and provided as part of a virtual switching framework (VSF); and
a commander switch coupled to at least one member switch among the plurality of member switches, the commander switch including control circuitry to cause the commander switch to:
assert a command to disable multicast traffic propagation through the VSF responsive to a determination that a change has occurred in the VSF;
alter the topology associated with the VSF from a first topology to a second topology responsive to the determination that the change has occurred;
receive a notification indicating that the topology associated with the VSF has been successfully altered from each member switch among the plurality of member switches; and
assert a command to re-enable multicast propagation through the VSF responsive to receipt of the notification that the topology associated with the VSF has been successfully altered.

9. The system of claim 8, wherein the change in the VSF comprises a failure of a member switch or a failure in communication link.

10. The system of claim 8, wherein the control circuitry is to cause the commander switch to:
synchronize multicast traffic through the VSF; and
provide control over each member switch among the plurality of member switches.

11. The system of claim 8, further comprising a standby switch coupled to the commander switch and at least one member switch among the plurality of member switches, the standby switch including control circuitry to cause the standby switch to:
provide control of the VSF responsive to a determination that the commander switch has failed;
assert a command to disable multicast traffic propagation through the VSF responsive to a determination that the commander switch has failed;
alter the topology associated with the VSF responsive to the determination that the commander switch has failed;
receive a notification indicating that the topology associated with the VSF has been successfully altered from each member switch among the plurality of member switches; and
assert a command to re-enable multicast propagation through the VSF responsive to receipt of the notification that the topology associated with the VSF has been successfully altered.

12. The system of claim 8, wherein the first topology is a ring topology and the second topology is a chain topology or standalone topology.

13. The system of claim 8, wherein the first topology is a chain topology or a standalone topology and the second topology is a ring topology.

14. The system of claim 8, wherein the respective communication links are front plane stacking links.

15. A method, comprising:
receiving a topology information update comprising information regarding a change in a topology associated with a virtual switching framework (VSF);
asserting a command to disable multicast traffic through the VSF responsive to a determination that a portion of the VSF has failed;
asserting a command to alter the topology associated with the VSF responsive to the determination that the portion of the VSF has failed;
receiving a notification from switches associated with the VSF indicating that the topology associated with the VSF has been altered; and
asserting a command to re-enable multicast traffic through the VSF responsive to receipt of the notification indicating that the topology associated with the VSF has been altered.

16. The method of claim 15, further comprising asserting the command to re-enable multicast traffic through the VSF via a plurality of front plane stack (FPS) links coupling the switches to one another.

17. The method of claim 15, further comprising:
receiving, at a commander switch, the notification from switches associated with the VSF indicating that the topology has been altered prior to asserting the command to re-enable multicast traffic through the VSF;
determining, at the commander switch, that each switch associated with the VSF has altered the topology associated with the VSF based on receipt of the notification from the switches associated with the VSF; and
asserting the command to re-enable multicast traffic through the VSF to each switch associated with the VSF via a unicast transmission.

18. The method of claim 15, wherein asserting the command to alter the topology associated with the VSF includes asserting a command to alter the topology from a ring topology to a chain topology.

19. The method of claim 15, further comprising asserting the command to alter the topology via a unicast transmission while multicast traffic is disabled through the VSF.

20. The method of claim 15, further comprising forwarding the command to disable multicast traffic in the VSF from a first switch associated with the VSF to a second switch associated with the VSF.
